(19) United States
(12) Patent Application Publication
(10) Pub. No.: US 2012/0024823 A1
(43) Pub. Date: Feb. 2, 2012

(54) COLLET ASSEMBLY WITH A UNIVERSAL COLLET

(75) Inventor: Derek YuFung Hung, Greenville, WI (US)

(73) Assignee: Illinois Tool Works Inc., Glenview, IL (US)

(21) Appl. No.: 13/184,220

(22) Filed: Jul. 15, 2011

Related U.S. Application Data
(60) Provisional application No. 61/368,377, filed on Jul. 28, 2010.

(51) Int. Cl. B23K 9/16

(52) U.S. Cl. 219/75; 219/136

(57) ABSTRACT

A collet assembly with a universal collet is provided. One collet assembly of a welding torch includes a collet having an outer diameter and an inner diameter. The inner diameter of the collet is configured to contact a welding electrode disposed through the collet. The welding torch also includes a spacer configured to be disposed in a welding torch head and to compress the collet against the welding electrode to secure the welding electrode in the torch.

### CROSS REFERENCE TO RELATED APPLICATIONS

This application is a Non-Provisional Patent Application of U.S. Provisional Patent Application No. 61/368,377 entitled “Universal Collet Assembly”, filed Jul. 28, 2010, which is herein incorporated by reference.

### BACKGROUND

The invention relates generally to welding torches and, more particularly, to a universal collet of a collet assembly for a welding torch.

Welding is a process that has become increasingly ubiquitous in various industries and applications. Such processes may be automated in certain contexts, although a large number of applications continue to exist for manual welding operations. In both cases, such welding operations rely on a variety of types of equipment to ensure that the supply of welding consumables (e.g., wire feed, shielding gas, etc.) and welding power are provided to the weld in an appropriate amount at the desired time.

Tungsten inert gas (TIG) welding, also known as gas tungsten arc welding (GTAW), is a type of welding process in which an electric arc is maintained between a metal electrode and a metal object. The heat generated by the arc produces localized melting of the metal object. The electrode, typically tungsten, is secured to a welding torch to enable a user to direct the electrode and establish the point of contact between the electrode and the object. Typically, the weld puddle and the area surrounding the weld puddle are protected from the atmosphere by a shielding gas. The shielding gas may prevent rapid oxidation of the weld and the surrounding metal.

A welding electrode may be secured to a TIG welding torch by a collet, a backcap, and a collet body, for example. To secure the electrode to the welding torch, the electrode is inserted through the collet and collet body. The collet body is attached to a front portion of a torch head disposed within the torch body. The backcap is attached to the rear portion of the torch head. As the backcap is coupled to the torch body, the backcap drives the collet against the interior of the collet body. The collet is adapted to pinch down on the electrode as the collet is driven against an interior surface of the collet body, thereby securing the electrode to the torch. Unfortunately, a unique collet size and shape may be needed for different types of welding torches. Therefore, there is a need in the field that provides alternatives to unique collet configurations for different types of welding torches.

### BRIEF DESCRIPTION

In one embodiment, a collet assembly of a welding torch includes a collet having an outer diameter and an inner diameter. The inner diameter of the collet is configured to contact a welding electrode disposed through the collet. The welding torch also includes a spacer configured to be disposed in a welding torch head and to compress the collet against the welding electrode to secure the welding electrode in the torch.

In another embodiment, a TIG welding torch includes a collet assembly including a collet and a spacer. The collet has an outer diameter and an inner diameter. The inner diameter of the collet is configured to contact a welding electrode disposed through the collet. The spacer is configured to be disposed in a welding torch head and to compress the collet against the welding electrode to secure the welding electrode in the torch.

In another embodiment, a TIG welding torch includes a welding electrode, a torch head coupled to a torch handle, and a collet assembly disposed in the torch head and configured to secure the welding electrode.

### DRAWINGS

These and other features, aspects, and advantages of the present invention will become better understood when the following detailed description is read with reference to the accompanying drawings in which like characters represent like parts throughout the drawings, wherein:

FIG. 1 is a perspective view of a welding system with a welding torch employing a collet assembly with a universal collet;

FIG. 2 is an exploded view of an embodiment of the welding torch assembly of FIG. 1;

FIG. 3 is an exploded view of another embodiment of the welding torch assembly of FIG. 1;

FIG. 4 is a side view of an embodiment of the collet assembly of the welding torch assembly of FIG. 2;

FIG. 5 is a side view of an embodiment of the collet assembly of the welding torch assembly of FIG. 3;

FIG. 6 is a perspective view of an embodiment of the collet of the collet assembly of FIG. 4; and

FIG. 7 is a perspective view of an embodiment of the collet of the collet assembly of FIG. 5.

### DETAILED DESCRIPTION

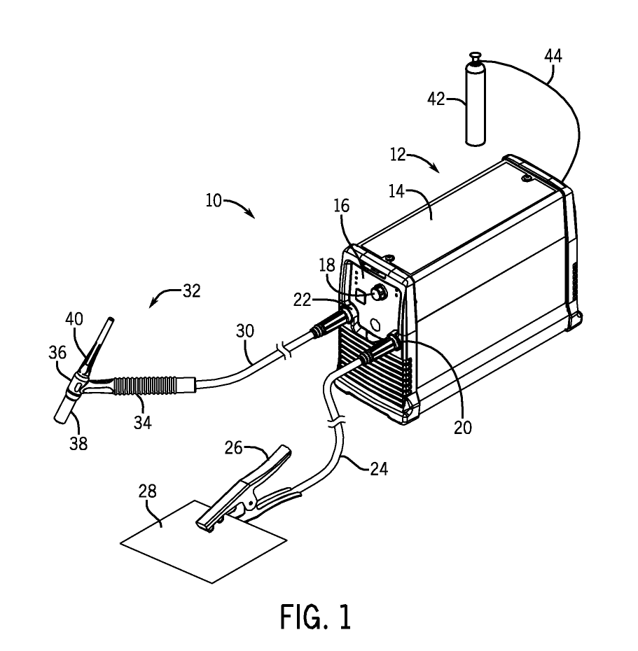

FIG. 1 is a perspective view of an exemplary welding system 10 employing a collet assembly with a universal collet. As appreciated, the welding system 10 may be utilized in a TIG welding process. The welding system 10 includes a welding power supply 12 having power conversion circuitry adapted to receive primary power and to convert the primary power to a weld power output suitable for use in a welding operation. For example, the primary power may be received from any primary source, such as a power grid, a generator, a wall outlet, and so forth. In some embodiments, the power conversion circuitry may be configured to output weld power at a substantially constant current.

In the illustrated embodiment, the welding power supply 12 includes a housing 14 having a top panel, side panels, a front panel, and a rear panel. In some embodiments, the top panel may include a handle that facilitates transport of the welding power supply 12 by an operator. Furthermore, the welding power supply 12 may include a controller configured to control operation of the welding power supply 12. The front panel of the welding power supply 12 includes a control panel 16 through which an operator may set one or more parameters of the welding process, for example, via knob 18 (or multiple knobs, buttons, touch screens, user interfaces, etc.).

The front of the welding power supply 12 also includes welding terminals 20 and 22. A work cable 24 terminating in a clamp 26 is attached to terminal 20 of the welding power supply 12. The clamp 26 is adapted to be clamped to a workpiece 28 during a welding operation. A weld cable 30 extends from terminal 22 to couple a welding torch assembly 32 to the welding power supply 12. When the welding torch assembly 32 is utilized in a welding operation to establish a welding arc, the clamp 26 is secured to the workpiece 28 to close the circuit between the welding power source 12, the workpiece, 28, and the welding torch 32.

The illustrated welding torch assembly 32 includes a torch handle 34 coupled to a torch head 36. The torch head 36 has a front section 38 and a back section 40 that together contain a welding electrode (e.g., tungsten electrode), a collet assembly, a collet body, and a backcap. As will be described in more detail below, the collet assembly includes a collet and a spacer. The collet is designed to be used in a variety of welding torch assemblies and with various sizes of welding electrodes. Shielding gas for the welding operation is supplied by a gas supply 42, such as a tank. The gas supply 42 may be coupled to the welding power supply 14 via a cable or hose 44 that directs shielding gas to the welding torch assembly 32.

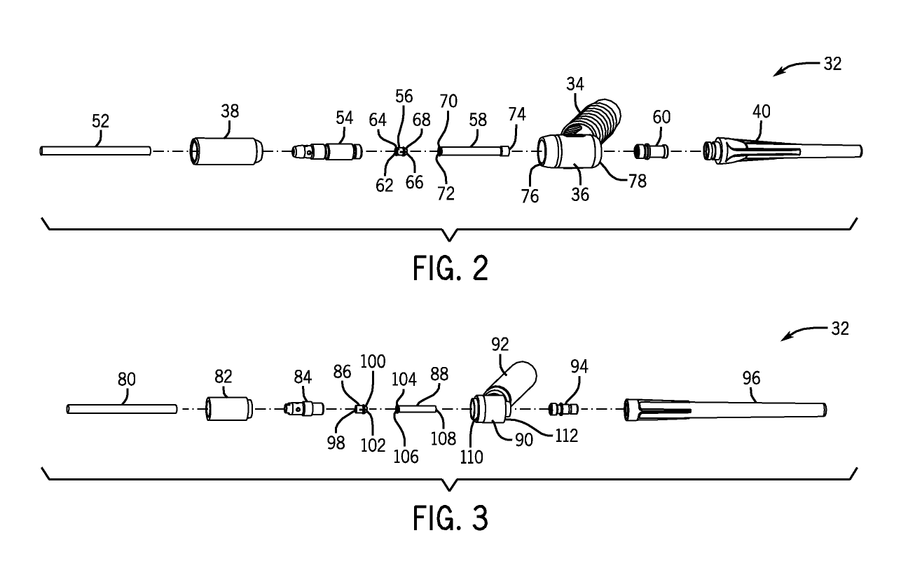

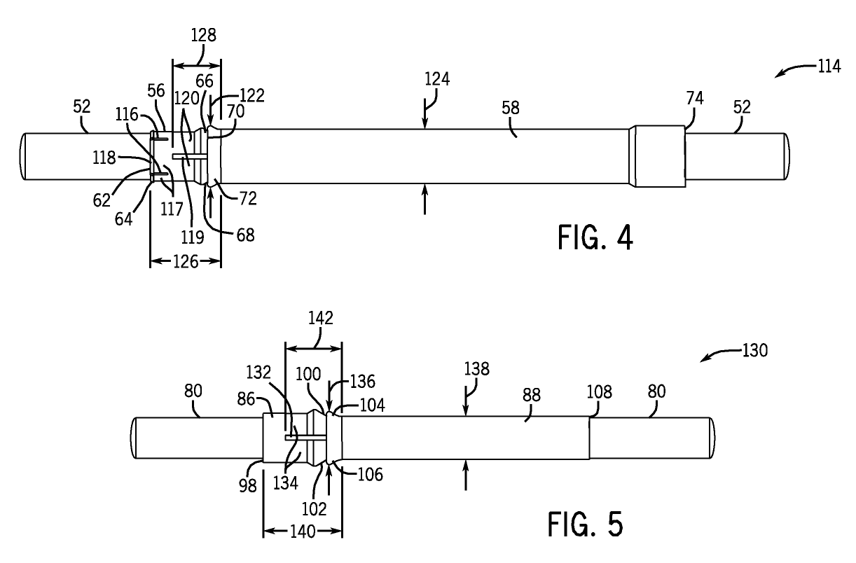

FIG. 2 is an exploded view of an embodiment of the welding torch assembly 32 of FIG. 1. The welding torch assembly 32 includes a welding electrode 52 that is used to establish a welding arc. In certain embodiments, the diameter of the welding electrode 52 may be approximately ⅛ inch. However, in other embodiments, the diameter of the welding electrode 52 may be in the range of approximately 1/50 inch to approximately 5/32 inch. The torch assembly 32 also includes a collet body 54, a collet 56, a spacer 58, and a backcap portion 60. In particular, the collet 56 includes a first end 62 that has a locking mechanism 64. The locking mechanism 64 is constructed so that the collet 56 can be inserted into the collet body 54 and locked in place within the collet body 54. In some embodiments, the collet 56 may not include the locking mechanism 64 so that the collet is not locked in place after being inserted into the collet body 54. A second end 66 of the collet 56 has a first tapered surface 68 as well as slits that divide the second end 66 into extensions, as illustrated in more detail in FIG. 4.

To assemble the welding torch assembly, the welding electrode 52 is inserted through the collet body 54, the collet 56, the spacer 58, the torch head 36, and the backcap portion 60. Further, the first tapered surface 68 of the collet 56 is inserted into a first end 70 of the spacer 58. When inserted into the spacer 58, the first tapered surface 68 of the collet 56 contacts a second tapered surface 72 of the spacer 58. The second tapered surface 72 of the spacer 58 compresses the first tapered surface 68 of the collet 56 against the welding electrode 52 to secure the collet 56 to the welding electrode 52 (e.g., to secure the welding electrode 52 in the torch).

The spacer 58 is disposed in the torch head 36 by inserting a second end 74 of the spacer 58 into a first end 76 of the torch head 36. In certain embodiments, the spacer 58 is inserted into the torch head 36 so that a portion of the spacer 58 and the collet 56 extend out of the first end 76 of the torch head 36, while the spacer 58 does not extend out of a second end 78 of the torch head 36. The backcap portion 60 is inserted into the second end 78 of the torch head 36. The backcap portion 60 in conjunction with the back section 40 form the backcap. As may be appreciated, the backcap may be formed by overmolding the back section 40 over the backcap portion 60. The backcap keeps the spacer 58 from exiting the torch head 36 via the second end 78 of the torch head 36. The backcap portion 60 is secured to the torch head 36 by pressing the backcap portion 60 into the second end 78 of the torch head 36. In certain embodiments, the backcap portion 60 and the torch head 36 may include threaded ends so that the backcap portion 60 is attached to the torch head 36 via rotating threads of the backcap portion 60 into threads of the torch head 36.

The collet body 54 is positioned around the collet 56 and a portion of the spacer 58, including the first end 70 of the spacer. The collet body 54 is inserted into the first end 76 of the torch head 36 and holds the collet 56 and spacer 58 (i.e., collet assembly) inside the torch head 36. The collet body 54 is secured to the torch head 36 by pressing the collet body 54 into the first end 76 of the torch head 36. In certain embodiments, the collet body 54 and the torch head 36 may include threaded ends so that the collet body 54 is attached to the torch head 36 via rotating threads of the collet body 54 into threads of the torch head 36. To finish assembling the torch assembly 32, the front section 38 is inserted into the first end 76 of the torch head 36 and secured to the torch head 36 by pressing the front section 38 into the first end 76 of the torch head 36. Likewise, the back section 40 is inserted into the second end 78 of the torch head 36 and secured to the torch head 36 by pressing the back section 40 into the second end 78 of the torch head 36. As may be appreciated, in certain embodiments, the front section 38, the back section 40, and the torch head 36 may also include threaded ends so that the front and back sections 38 and 40 are attached to the torch head 36 via rotating threads of the front and back sections 38 and 40 into threads of the torch head 36.

It should be noted that welding power flows through the collet 56 to the welding electrode 52. For the welding power to flow to the welding electrode 52, there is contact between the extensions of the collet 56 and the welding electrode 52. The contact between the collet 56 and the welding electrode 52 results from the collet 56 being inserted into the first end 70 of the spacer 58. The second tapered surface 72 of the spacer 58 makes contact with the first tapered surface 68 of the collet 56 and presses the extensions of the collet 56 against the welding electrode 52. As may be appreciated, when contact area between the collet 56 and the welding electrode 52 increases, the electrical resistance between the collet 56 and the welding electrode 52 decreases. As the resistance decreases, less heat is present where the collet 56 contacts the welding electrode 52. In certain embodiments, the heat present where the collet 56 contacts the welding electrode 52 is lower than in configurations without the universal collet 56 as disclosed herein.

FIG. 3 is an exploded view of another embodiment of the welding torch assembly 32 of FIG. 1. This embodiment of the welding torch assembly 32 is very similar to the torch assembly 32 of FIG. 2, but may be used in different applications, such as in welding applications that utilize a welding electrode with a different diameter than the welding electrode 52. In particular, the welding torch assembly 32 includes a welding electrode 80 that is used to establish a welding arc. In certain embodiments, the diameter of the welding electrode 80 may be approximately 3/32 inch. However, in other embodiments, the diameter of the welding electrode 80 may be in the range of approximately 1/50 inch to approximately 5/32 inch. The torch assembly 32 also includes a front section 82, a collet body 84, a collet 86, a spacer 88, a torch head 90, a torch handle 92, a backcap portion 94, and a back section 96. Furthermore, the collet 86 includes a first end 98 that does not include a locking mechanism. A second end 100 of the collet 86 has a first tapered surface 102 as well as slits that divide the second end 100 into extensions, as illustrated in more detail in FIG. 5.

To assemble the welding torch assembly, the welding electrode 80 is inserted through the collet body 84, the collet 86, the spacer 88, the torch head 90, and the backcap portion 94. Further, the first tapered surface 102 of the collet 86 is inserted into a first end 104 of the spacer 88. When inserted into the spacer 88, the first tapered surface 102 of the collet 86 contacts a second tapered surface 106 of the spacer 88. The second tapered surface 106 of the spacer 88 compresses the first tapered surface 102 of the collet 86 against the welding electrode 80 to secure the collet 86 to the welding electrode 80.

The spacer 88 is disposed in the torch head 90 by inserting a second end 108 of the spacer 88 into a first end 110 of the torch head 90. In certain embodiments, the spacer 88 is inserted into the torch head 90 so that a portion of the spacer 88 and the collet 86 extend out of the first end 110 of the torch head 90, while the spacer 88 does not extend out of a second end 112 of the torch head 90. The backcap portion 94 is inserted into the second end 112 of the torch head 90. The backcap portion 94 in conjunction with the back section 96 form the backcap. As may be appreciated, the backcap may be formed by overmolding the back section 96 over the backcap portion 94. The backcap keeps the spacer 88 from exiting the torch head 90 via the second end 112 of the torch head 90. The backcap portion 94 is secured to the torch head 90 by pressing the backcap portion 94 into the second end 112 of the torch head 90.

The collet body 84 is positioned around the collet 86 and a portion of the spacer 88, including the first end 104 of the spacer. The collet body 84 is inserted into the first end 110 of the torch head 90 and holds the collet 86 and spacer 88 (i.e., collet assembly) inside the torch head 90. The collet body 84 is secured to the torch head 90 by pressing the collet body 84 into the first end 110 of the torch head 90. To finish assembling the torch assembly 32, the front section 82 is inserted into the first end 110 of the torch head 90 and secured to the torch head 90 by pressing the front section 82 into the first end 110. Likewise, the back section 96 is inserted into the second end 112 of the torch head 90 and secured to the torch head 90 by pressing the back section 96 into the second end 112.

The collets 56 and 86 disclosed in FIGS. 2 and 3 are constructed to be universal (i.e., work with a wide variety of welding torches rather than a single style of welding torch). As described in FIG. 2, collet 56 includes a locking mechanism 64, while collet 86 of FIG. 3 does not include a locking mechanism. However, it should be noted, that the remaining features of the collets 56 and 86 allow the collets to be interchangeable and to be used within either embodiment of the welding torch assembly 32. For example, the collet 86 of FIG. 3 may be used in the welding torch assembly 32 of FIG. 2. Furthermore, the collet 56 of FIG. 2 may be used in the welding torch assembly 32 of FIG. 3. Likewise, collets 56 and 86 may be used in additional styles of welding torch assemblies.

FIG. 4 is a side view of an embodiment of a collet assembly 114 of the welding torch assembly 32 of FIG. 2. As previously described, the collet assembly 114 includes the collet 56 and the spacer 58. FIG. 4 depicts the welding electrode 52 extending through the collet assembly 114. As illustrated, the first end 62 of the collet 56 includes the locking mechanism 64. The locking mechanism 64 is formed by slits 116 that create extensions 117. The extensions 117 form a locking edge 118 to lock the collet 56 inside of the collet body 54 of FIG. 3 when the first end 62 of the collet 56 is inserted into the collet body 54. As may be appreciated, the locking mechanism 64 may be constructed in another manner, such as with any type of press fit, snap, or other mechanism to lock together the collet 56 and the collet body 54. Furthermore, as described in relation to the collet 86 of FIG. 3, the collet 56 may not include a locking mechanism 64.

The second end 66 of the collet 56 has the first tapered surface 68 that is illustrated as extending within the second tapered surface 72 found on the first end 70 of the spacer 58. The second end 66 of the collet 56 has slits 119 that form extensions 120. As the extensions 120 are inserted into the first end 70 of the spacer 58, the extensions 120 are pressed toward the welding electrode 52 and the extensions 120 are deformed by the spacer 58 to contact the welding electrode 52. As may be appreciated, the slits 119 permit the extensions 120 to move and contact the welding electrode 52.

As depicted, the second tapered surface 72 of the spacer 58 creates a flared edge on the first end 70. As such, an outer diameter 122 of the first end 70 is greater than an outer diameter 124 of the spacer 58. Furthermore, the change in the outer diameter from diameter 122 to diameter 124 also corresponds to an inner diameter change. In addition, the diameter change corresponds to a change in the diameter of the second tapered surface 72. The collet 56 has a length 126, while the slits 119 have a length 128. Specifically, the length 126 of the collet 56 may be approximately 0.2 to 0.8 inches. In certain embodiments, the length 126 of the collet 56 may be approximately 0.5 inches. Further, the length 128 of the slits 119 may be approximately 0.1 to 0.6 inches. In certain embodiments, the length 128 of the slits 119 may be approximately 0.4 inches.

The collet 56 may be considerably shorter, such as by at least approximately 75 percent, than non-universal collets (e.g., collets that are not designed to be universal as disclosed). Furthermore, the slits 119 may be at least approximately 50 percent shorter than slits used in non-universal collets. As such, the extensions 120 have an increased resistance to breaking when compared to extensions that may be found in non-universal collets. As may be appreciated, the diameter of the welding electrode 52 may vary depending on the welding application. For example, in certain embodiments, the welding electrode 52 may have a diameter of approximately 3/32 inch to approximately 5/32 inch. It should be noted that the collet assembly 114 (i.e., the collet 56 and the spacer 58) may be formed using any variety of conductive materials, such as various metals including brass, copper, another metal or alloy, etc. For example, the collet 56 and the spacer 58 may be formed using brass.

FIG. 5 is a side view of an embodiment of a collet assembly 130 of the welding torch assembly 32 of FIG. 3. As previously described, the collet assembly 130 includes the collet 86 and the spacer 88. The welding electrode 80 is illustrated extending through the collet assembly 130. The second end 100 of the collet 86 has the first tapered surface 102 that is illustrated as extending within the second tapered surface 106 found on the first end 104 of the spacer 88. The second end 100 of the collet 86 has slits 132 that form extensions 134. As the extensions 134 are inserted into the first end 104 of the spacer 88, the extensions 134 are pressed toward the welding electrode 80 and the extensions 134 are deformed by the spacer 88 to contact the welding electrode 80. As may be appreciated, the slits 132 permit the extensions 134 to move and contact the welding electrode 80.

As depicted, the second tapered surface 106 of the spacer 88 creates a flared edge on the first end 104. As such, an outer diameter 136 of the first end 104 is greater than an outer diameter 138 of the spacer 88. Furthermore, the change in the outer diameter from diameter 136 to diameter 138 also corresponds to an inner diameter change. The diameter change also corresponds to a change in the diameter of the second tapered surface 106. The collet 86 has a length 140, while the slits 132 have a length 142. Specifically, the length 140 of the collet 86 may be approximately 0.2 to 0.8 inches. In certain embodiments, the length 142 of the collet 86 may be approximately 0.5 inches. Further, the length 142 of the slits 132 may be approximately 0.1 to 0.6 inches. In certain embodiments, the length 142 of the slits 132 may be approximately 0.4 inches.

As may be appreciated, the diameter of the welding electrode 80 may vary depending on the welding application. For example, in certain embodiments, the welding electrode 80 may have a diameter of approximately 3/32 inch to approximately 5/32 inch. Similar to the collet assembly 114 of FIG. 4, the collet assembly 130 (i.e., the collet 86 and the spacer 88) may be formed using any variety of conductive materials, such as various metals including brass, copper, another metal or alloy, etc. For example, the collet 86 and the spacer 88 may be formed using brass.

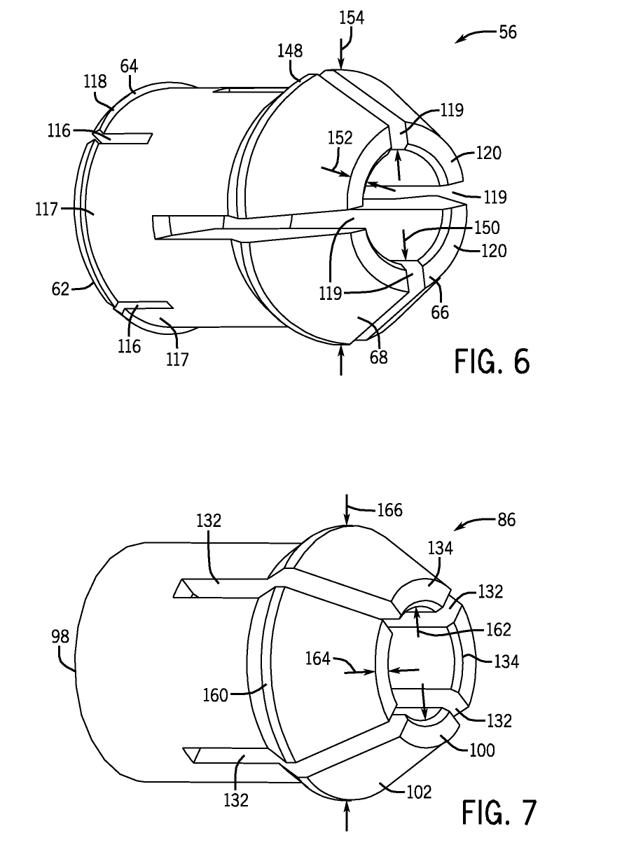

FIG. 6 is a perspective view of an embodiment of the collet 56 of the collet assembly 114 of FIG. 4. As illustrated, the collet 56 includes four slits 119 that divide the second end 66 into four extensions 120. Likewise, there are four slits 116 that divide the first end 62 into four extensions 117, although only two slits 116 are visible in FIG. 4. The first tapered surface 68 extends from the second end 66 toward the first end 62. As the first tapered surface 68 moves away from the second end 66, the outside diameter increases until the tapered surface 68 ends at a ridge 148. Further, at the second end 66, the collet 56 has an inner diameter 150. The inner diameter 150 is sufficient to enable the welding electrode 52, which may have a range of diameters, to be disposed therein. As such, the inner diameter 150 may be within the range of approximately 3/32 inch to approximately 7/32 inch. In addition, the inner diameter 150 is configured to contact the welding electrode 52 disposed through the collet 56. An outer diameter of the collet 56 at the second end 66 is the sum of the inner diameter 150 and a thickness 152 of the material at the second end 66 of the extensions 120. As previously discussed, the outer diameter increases along the first tapered surface 68 from the second end 66 to the ridge 148 which has a diameter 154.

FIG. 7 is a perspective view of an embodiment of the collet 86 of the collet assembly 130 of FIG. 5. Similar to collet 56 of FIG. 6, the collet 86 includes four slits 132 that divide the second end 100 into four extensions 134. The first tapered surface 102 extends from the second end 100 toward the first end 98. As the first tapered surface 102 moves away from the second end 100, the outside diameter increases until the tapered surface 102 ends at a ridge 160. Further, at the second end 100, the collet 86 has an inner diameter 162. The inner diameter 162 is sufficient to enable the welding electrode 80, which may have a range of diameters, to be disposed therein. As such, the inner diameter 162 may be within the range of approximately 3/32 inch to approximately 7/32 inch. In addition, the inner diameter 162 is configured to contact the welding electrode 80 disposed through the collet 86. An outer diameter of the collet 86 at the second end 100 is the sum of the inner diameter 162 and a thickness 164 of the material at the second end 100 of the extensions 134. The outer diameter increases along the first tapered surface 102 from the second end 100 to the ridge 160 which has a diameter 166.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A collet assembly of a welding torch comprising:
a collet having an outer diameter and an inner diameter, the inner diameter being configured to contact a welding electrode disposed through the collet; and
a spacer configured to be disposed in a welding torch head and to compress the collet against the welding electrode to secure the welding electrode in the torch.

2. The collet assembly of claim 1, wherein the collet comprises a plurality of slits dividing a portion of the collet into extensions that are deformed by the spacer to contact the welding electrode.

3. The collet assembly of claim 2, wherein the plurality of slits comprises four slits.

4. The collet assembly of claim 1, wherein the collet comprises a locking mechanism to lock the collet to a collet body.

5. The collet assembly of claim 1, wherein the inner diameter of the collet is configured to contact a welding electrode with an electrode diameter range of approximately 1/16 inch to approximately 5/32 inch.

6. The collet assembly of claim 1, wherein the outer diameter of the collet comprises a first tapered surface.

7. The collet assembly of claim 6, wherein the spacer comprises a second tapered surface that contacts the first tapered surface of the collet to compress the collet against the welding electrode to secure the welding electrode in the torch.

8. A TIG welding torch comprising:
a collet assembly having a collet and a spacer, the collet has an outer diameter and an inner diameter, the inner diameter being configured to contact a welding electrode disposed through the collet, and the spacer being configured to be disposed in a welding torch head and to compress the collet against the welding electrode to secure the welding electrode in the torch.

9. The TIG welding torch of claim 8, comprising a welding electrode disposed through the collet, the inner diameter of the collet contacting the welding electrode.

10. The TIG welding torch of claim 8, comprising a welding torch head, the spacer disposed in the welding torch head.

11. The TIG welding torch of claim 8, comprising a back cap contacting one end of the spacer.

12. The TIG welding torch of claim 8, comprising a collet body contacting the collet.

13. The TIG welding torch of claim 12, wherein the collet comprises a locking mechanism and the collet body is locked to the collet via the locking mechanism.

14. The TIG welding torch of claim 8, wherein the outer diameter of the collet comprises a first tapered surface and the spacer comprises a second tapered surface that contacts the first tapered surface of the collet to compress the collet against the welding electrode to secure the welding electrode in the torch.

15. A TIG welding torch comprising:
a welding electrode;
a torch head coupled to a torch handle; and
a collet assembly disposed in the torch head and configured to secure the welding electrode.

16. The TIG welding torch of claim 15, wherein the collet assembly is configured to contact a welding electrode with an electrode diameter range of approximately 3/32 inch to approximately ⅛ inch.

17. The TIG welding torch of claim 15, comprising a collet body and a back cap, the collet body contacting one end of the collet assembly and the back cap contacting the other end of the collet assembly.

18. The TIG welding torch of claim 15, wherein the collet assembly comprises a collet and a spacer.

19. The TIG welding torch of claim 18, wherein the collet is inserted into the spacer to compress the collet against the welding electrode to secure the welding electrode in the torch.

20. The TIG welding torch of claim 18, wherein the collet comprises a locking mechanism to lock the collet to a collet body.
